(19) United States
(12) Patent Application Publication
(10) Pub. No.: US 2014/0186590 A1
(43) Pub. Date: Jul. 3, 2014

(54) TOUCH PANEL INTEGRATED WITH COVER GLASS AND MANUFACTURING METHOD THEREOF

(71) Applicant: SAMSUNG ELECTRO-MECHANICS CO., LTD., Suwon-si (KR)

(72) Inventor: Jin-Mun RYU, Gyeonggi-do (KR)

(73) Assignee: SAMSUNG ELECTRO-MECHANICS CO., LTD., Suwon-si (KR)

(21) Appl. No.: 14/051,017

(22) Filed: Oct. 10, 2013

(30) Foreign Application Priority Data
Dec. 28, 2012 (KR) 10-2012-0157168

(51) Int. Cl. G02F 1/1333

(52) U.S. Cl. CPC G02F 1/13338
USPC 428/192; 427/79; 427/554; 216/17

(57) ABSTRACT

Disclosed herein are a touch panel integrated with a cover glass and a manufacturing method thereof. The manufacturing method of a touch panel integrated with a cover glass includes: providing a sheet shaped glass substrate; forming grooves in cut regions of the glass substrate; forming a chemical tempered layer on a surface of the glass substrate and groove portions through chemical tempering; and cutting the glass substrate along the groove.

### CROSS REFERENCE(S) TO RELATED APPLICATIONS

This application claims the benefit under 35 U.S.C. Section 119 of Korean Patent Application Serial No. 10-2012-0157168, entitled “Touch Panel Integrated with Cover Glass and Manufacturing Method Thereof” filed on Dec. 28, 2012, which is hereby incorporated by reference in its entirety into this application.

### BACKGROUND OF THE INVENTION

1. Technical Field

The present invention relates to a touch panel integrated with a cover glass and a manufacturing method thereof.

2. Description of the Related Art

A manufacturing method of a capacitive type touch panel integrated with a cover glass may be divided into a cell type manufacturing method and a sheet type manufacturing method.

The cell type manufacturing method of a touch panel integrated with a cover glass is performed by repeating a PR coating process, an exposure process, a development process, a washing process, a drying process, an electrode sputtering process, a separating process, a washing process, a drying process, and a transparent coating process using cover glass chemical tempered in advance in a cell unit to form X-axis and Y-axis electrodes and a transparent sheet.

The sheet type manufacturing method of a touch panel integrated with a cover glass is performed by repeating a PR coating process, an exposure process, a development process, a washing process, a drying process, an electrode sputtering process, a separating process, a washing process, a drying process, and a transparent coating process using plate glass chemical tempered in advance in a sheet shape to complete a sensor process, and then cutting the completed sheet in the cell unit.

However, in the cell type manufacturing method according to the related art, since the cover glass is tempered in the cell unit, strength of the cover glass may be excellent, but it may be difficult to manufacture a touch panel, such that quality may be deteriorated.

In addition, in the sheet type manufacturing method, since the sensor process is performed after the plate glass is tempered, there are advantages such as low cost and high productivity, but since the cover glass is cut after the sensor is completed, sides of the cover glass are not tempered, such that strength may not be reliable, that is, the strength of the cover glass may be deteriorated.

A manufacturing method of a glass chip including forming a groove in a glass substrate, performing chemical treatment on the substrate using ion exchange to form a tempered layer, and applying external force to a groove portion to divide the glass substrate has been disclosed in Patent Document 1 (Japanese Patent), and a method for manufacturing an electric solid-state device in which a region scheduled to be cut is exposed by an etching protection layer, a groove is formed in the cut etching region, and a protective layer is formed on a surface, such that the cutting is performed along the groove, and an electric solid-state device have been disclosed in Patent Document 2 (Japanese Patent).

### RELATED ART DOCUMENT

### Patent Document

(Patent Document 1) Japanese Patent Laid-Open Publication No. 2012-076949

(Patent Document 2) Japanese Patent Laid-Open Publication No. 2011-164508

### SUMMARY OF THE INVENTION

An object of the present invention is to provide a touch panel integrated with a cover glass capable of preventing strength of the cover glass from being deteriorated while maintaining high productivity by forming grooves in both surfaces of a tempered glass substrate and tempering the surface and then cutting groove formed regions, and a manufacturing method thereof.

According to an exemplary embodiment of the present invention, there is provided a manufacturing method of a touch panel integrated with a cover glass, the manufacturing method including: providing a sheet shaped glass substrate; forming grooves in cut regions of the glass substrate; forming a chemical tempered layer on a surface of the glass substrate and groove portions through chemical tempering; and cutting the glass substrate along the groove, wherein a thickness D of the chemical tempered layer of the surface of the glass substrate is thicker than a thickness d of the chemical tempered layer on the groove portion.

The manufacturing method may further include, between the forming of the chemical tempered layer and the cutting of the glass substrate, printing black decoration on one surface of the glass substrate; and forming a step coating layer on the glass substrate so as to cover the black decoration.

The manufacturing method may further include, between the forming of the step coating layer and the cutting of the glass substrate, forming stripe type electrodes on the step coating layer in a first axis direction; forming a first transparent coating layer so as to cover the stripe type electrodes in the first axis direction; forming stripe type electrodes on the first transparent coating layer in a second axis direction intersecting with the first axis direction; and forming a second transparent coating layer so as to cover the stripe type electrode in the second axis direction.

An aspect ratio of a kerf to a depth of the groove may be 1.0 to 3.0.

The cutting of the glass substrate may include modifying the groove portion by bringing laser focus on the groove portion and moving the laser focus along the groove.

The cutting may be performed by at least one method selected from a group consisting of a laser cutting method, a water jet cutting method, and an etching method.

The manufacturing method may further include, between the forming of the groove and the forming of the chemical tempered layer, filling the groove with a filler.

The manufacturing method may further include, after the cutting of the glass substrate, removing the filler.

The manufacturing method may further include, after the cutting of the glass substrate, performing at least one healing treatment selected from a group consisting of etching treatment and brushing treatment.

According to another exemplary embodiment of the present invention, there is provided a touch panel integrated with a cover glass including: a cell shaped glass substrate; a processed part formed at an edge of the glass substrate; a first chemical tempered layer formed on a surface of the glass substrate; and a second chemical tempered layer formed on the processed part, wherein the first chemical tempered layer has a thickness thicker than that of the second chemical tempered layer.

The glass substrate may be formed in a square shape having a predetermined thickness, and the process part may correspond to four sides of the square.

The second chemical tempered layer may have a thickness decreased toward an end portion of the glass substrate.

The cell shaped glass substrate may be formed by forming grooves along predetermined cutting lines of a sheet shaped glass substrate, performing chemical tempering on the glass substrate, and cutting the glass substrate along the grooves. The groove may be filled with a filler.

Black decoration may be printed on one surface of the sheet shaped glass substrate so as to correspond to a shape of the cell, and a step coating layer may be formed on one surface of the sheet shaped glass substrate so as to cover the black decoration.

A first transparent coating layer including stripe type electrodes in a first axis direction may be stacked on the step coating layer, and a second transparent coating layer including stripe type electrodes in a second axis direction intersecting with the first axis direction may be stacked on the first transparent coating layer.

An aspect ratio of a kerf to a depth of the groove may be 1.0 to 3.0. The processed part may be modified by laser processing.

### BRIEF DESCRIPTION OF THE DRAWINGS

FIG. 1 is a flow chart showing a manufacturing method of a touch panel integrated with a cover glass according to an exemplary embodiment of the present invention.

FIGS. 2A to 2O are flow charts showing a manufacturing process of the touch panel integrated with a cover glass according to the exemplary embodiment of the present invention.

FIGS. 3A to 3C are flow charts showing a processing process of a glass substrate according to the exemplary embodiment of the present invention.

FIG. 4 is a cross-sectional view showing a sheet shaped glass substrate according to the exemplary embodiment of the present invention.

FIGS. 5A and 5B are cross-sectional views showing a cell shaped glass substrate according to the exemplary embodiment of the present invention.

FIG. 6 is conceptual view showing a chemical tempering process according to the exemplary embodiment of the present invention.

FIG. 7 is conceptual view showing a chemical tempered layer of a groove portion according to the exemplary embodiment of the present invention.

FIGS. 8A to 8C are cross-sectional views showing grooves according to the exemplary embodiment of the present invention.

FIGS. 9A to 9F are photographs of the grooves of FIGS. 8A to 8C.

FIG. 10 is a graph showing relationship of a thickness of the chemical tempered layer to an aspect ratio of each of the grooves of FIGS. 8A to 9F.

FIG. 11 is conceptual view showing a laser cutting process according to the exemplary embodiment of the present invention.

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the specification denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In the drawings, the thickness of layers and regions is exaggerated for efficient description of the technical contents. Therefore, exemplified forms may be changed according to manufacturing technologies and/or tolerance. Therefore, the exemplary embodiments of the present invention are not limited to specific forms but may include the change in forms generated according to the manufacturing processes. For example, an etching region vertically shown may be rounded or may have a predetermined curvature.

Hereinafter, a touch panel integrated with a cover glass and a manufacturing method thereof according to exemplary embodiments of the present invention will be described in detail with reference to the accompanying drawings.

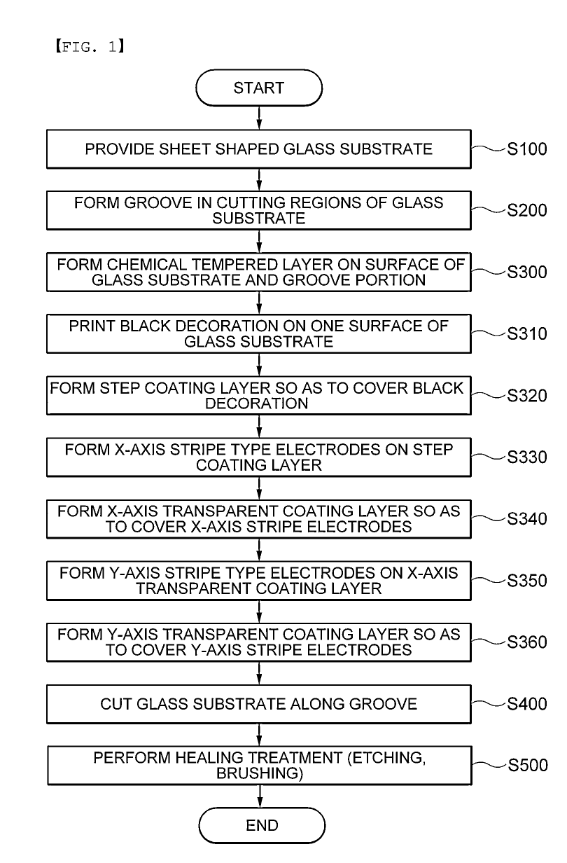

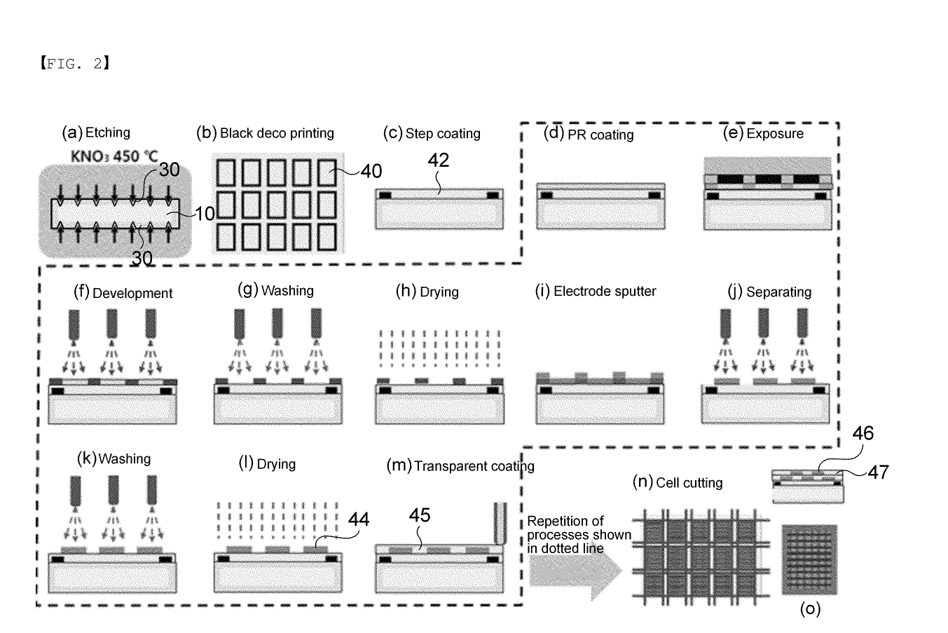

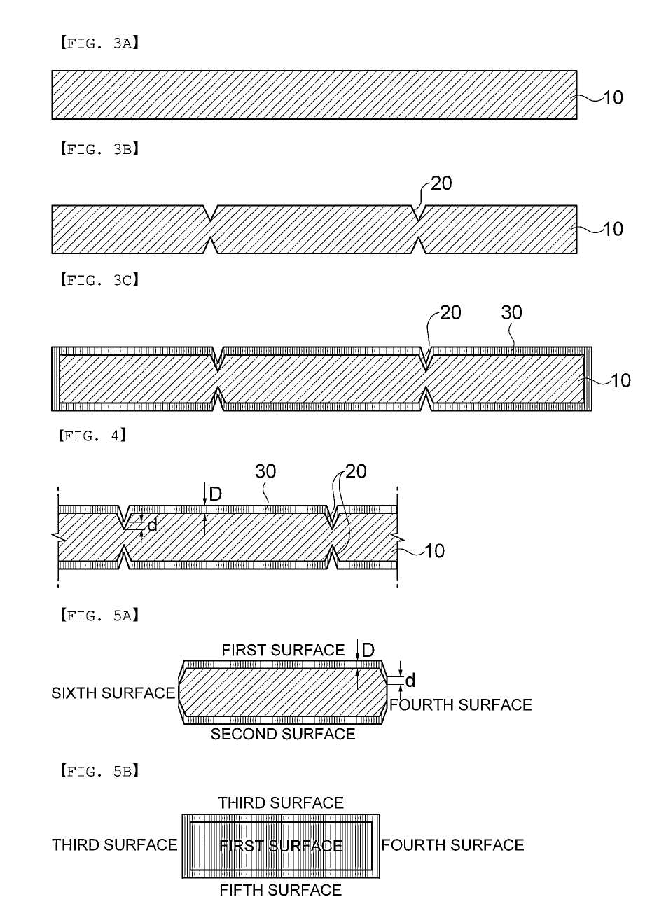

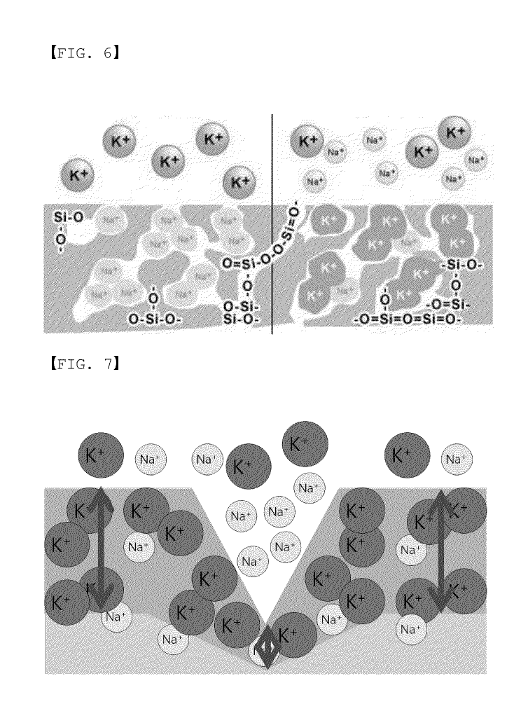

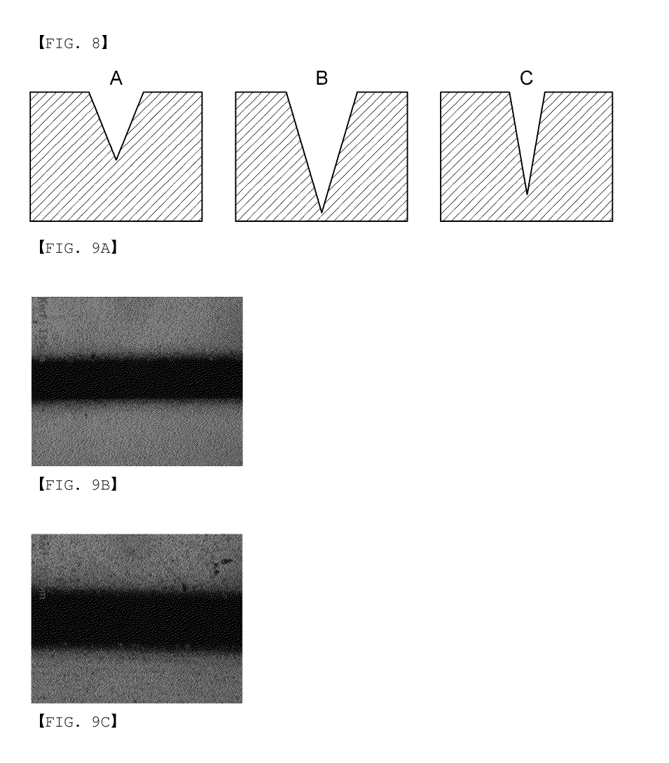

FIG. 1 is a flow chart showing a manufacturing method of a touch panel integrated with a cover glass according to an exemplary embodiment of the present invention; FIG. 2 is a process flow chart showing a manufacturing process of the touch panel integrated with a cover glass according to the exemplary embodiment of the present invention; FIG. 3 is a flow chart showing a processing process of a glass substrate according to the exemplary embodiment of the present invention; and FIG. 4 is a cross-sectional view showing a sheet shaped glass substrate according to the exemplary embodiment of the present invention. Referring to FIGS. 2A to 4, a glass substrate 10, a groove 20, a chemical tempered layer 30, a black decoration 40, a step coating layer 42, an X-axis stripe type electrode 44, an X-axis transparent coating layer 45, a Y-axis stripe type electrode 46, and a Y-axis transparent coating layer 47 are shown.

A touch screen panel is an input device of selecting an instruction content shown on a screen of an image display device, or the like, using a hand of the user or an object to allow order of the user to be input.

To this end, the touch screen panel converts a touch position provided in a front face of the image display device and directly touched by the hand of the user or the object into an electric signal. Therefore, the instruction content selected at the touch position is received as the input signal.

As described above, since the touch screen panel may substitute a separate input device connected to the image display device to be operated such as a keyboard and a mouse, a usage range of the touch screen panel has increased.

The touch panel is classified into a capacitive type touch panel, a resistive type touch panel, an infrared beam type touch panel, an integral strain gauge type touch panel, a surface acoustic wave type touch panel, and a piezo electric type touch panel according to an operation scheme thereof.

For example, describing a structure of a capacitive type touch screen panel, the capacitive type touch screen panel is configured of an upper transparent sheet on which an upper transparent film to which an electric field is applied in a Y-axis direction is formed so as to be attached to an upper plate of a display panel and a lower transparent sheet on which a lower transparent film to which the electric field is applied in an X-axis direction is formed.

The upper and lower transparent films may be made of a material having excellent transmittance and resistance of about several hundreds Ω, for example, indium tin oxide (ITO).

A lower portion of the upper transparent film is provided with the X-axis stripe type electrodes. These X-axis stripe type electrodes may be formed by printing silver (Ag) on the upper transparent film.

The X-axis stripe type electrodes may be formed on the upper transparent film and connected to a tail wiring having a pad terminal at a central portion of a lower edge of the upper transparent film to thereby receive power from the tail wiring.

Both sides of the lower transparent film are provided with the Y-axis stripe type electrodes. These Y-axis stripe type electrodes may be formed by printing silver (Ag) on the lower transparent film.

The Y-axis stripe type electrodes may be formed on the lower transparent film and connected to a tail wiring having a pad terminal at a central portion of a lower edge of the lower transparent film to thereby receive power from the tail wiring.

As described above, silver (Ag) electrode wirings are formed on upper and lower portions of the touch panel. A size of the touch panel depends on a wiring interval of the electrode as described above and a distance between the electrode and a distal end of the panel, and decoration ink is printed on window glass so that the tail wiring as described above is not shown on the outside.

Decoration printing of a bezel portion as describe above is generally performed by a silk screen printing method on the window glass several times.

As the demand for the capacitive type touch panel is increased, a structure of the touch panel is changed. According to the related art, a GG type touch panel and a GFF type touch panel that independently include a sensor part between a cover and a display has been mainly used, but recently, in order to improve characteristics and reduce cost, a product in which a cover glass or display has a function of the touch panel has been developed.

That is, an on-cell type touch panel in which a pattern layer is formed on a display substrate, an in-cell type touch panel in which a pattern layer is formed in display, a touch panel integrated with a cover glass (direct patterned window (DPW), glass 2 layer (G2), glass one module (G1M), one glass solution (OGS), advanced technology touch (ATT), or the like) are developed.

Among them, the touch panel integrated with a cover glass is expected as a measure for thinness and low cost.

As described above, a manufacturing method of a capacitive type touch panel integrated with a cover glass may be divided into a cell type manufacturing method and a sheet type manufacturing method, and each of the method has advantages and disadvantages.

The embodiment of the present invention, which is to solve problems of the sheet type manufacturing method, is characterized by minimizing a chip generated in a cut surface in order to significantly decrease a decrease in strength of the glass substrate during a process of cutting a sheet after manufacturing a sensor of the touch panel integrated with a cover glass.

To this end, in the manufacturing method of a touch panel integrated with a cover glass, a groove is formed in advance at a region of sheet glass scheduled to be cut, and then chemical tempering is performed, such that a solution does not smoothly flow in the groove, and ion substitution is not activated. As a result, a depth of layer (DoL) at this portion is not deeper than those of other surfaces.

Therefore, in the case in which cutting the sheet along the processed groove after manufacturing the sensor, the strength of the cover glass may be maintained.

As a cutting method of the groove, there are a laser cutting method, a water jet cutting method, an etching method, and the like. After cutting, a healing treatment such as etching treatment, brushing treatment, or the like, is performed, such that the decrease in the strength after tempering may be complemented.

In order to manufacture the touch panel integrated with a cover glass according to the present invention, first, a sheet shaped glass substrate 10 is provided (S100), and a groove 20 is formed in advance in a region of the glass substrate 10 to be cut (S200).

Next, the chemical tempering is performed, such that a chemical tempered layer 30 is stacked on a surface of the glass substrate 10 and a groove 20 portion (S300).

Finally, the glass substrate is cut, and particularly, the region of the groove 20 processed in advance is cut, such that strength of the glass substrate 10 cut in the cell unit may not be decreased.

The entire manufacturing process of the touch panel integrated with a cover glass is shown in FIG. 2.

As shown in FIG. 2B, black decoration 40 is printed on a back surface of the glass substrate chemical tempered as shown in FIG. 2A (provided with the chemical tempered 30) (S310), and then the step coating layer 42 is formed so as to cover the black decoration 40 as shown in FIG. 2C (S320).

Then, a stacking of the transparent sheet (a portion shown by dotted line in FIG. 2) is performed.

That is, the X-axis stripe type electrode 44 is formed on the step coating layer 42 as shown in FIGS. 2D to 2I (S330), and the X-axis transparent coating layer 45 is formed so as to cover the stripe type electrode 44 as shown in FIG. 2M (S340). Therefore, the lower transparent sheet may be formed.

Again, the Y-axis stripe type electrode 46 is formed on the X-axis transparent coating layer 45 by performing the processes of FIGS. 2D to 2I (S350), and the Y-axis transparent coating layer 47 is formed so as to cover the stripe type electrode 46 (S360). Therefore, the upper transparent sheet may be formed.

Here, the case in which the lower transparent sheet is formed with the X-axis stripe type electrode 44 and the upper transparent sheet is formed with the Y-axis strip type electrode 46 is described by way of example, but on the contrary, the lower transparent sheet may be formed with the Y-axis stripe type electrode and the upper transparent sheet may be formed with the X-axis strip type electrode.

Next, as shown in FIG. 2N, the glass substrate 10 is cut along the groove 20 formed in advance in the glass substrate 10, such that the touch panel may be manufactured in the cell unit.

After cutting the glass substrate 10, the healing treatment such as etching treatment, brushing treatment, or the like, may be performed as described above (S500).

The processes of forming the groove 20 in advance in the glass substrate 10 according to the present invention, performing the chemical tempering on the glass substrate 10, and then cutting the glass substrate 10 are shown in FIGS. 3A to 3C.

That is, the groove 20 is formed in advance as shown in FIG. 3B in the sheet shaped glass substrate 10 provided as shown in FIG. 3A, and the chemical tempering is performed thereon as shown in FIG. 3C, and then, the glass substrate 10 may be cut along the groove as described above.

In this case, in the manufacturing method of a touch panel according to the exemplary embodiment of the present invention, the glass substrate 10 is processed so that a thickness D of the chemical tempered layer 30 on the glass substrate 10 is thicker than a thickness d of the chemical tempered layer 30 on the groove 20 portion, as shown in FIG. 4.

The reason is that the solution does not smoothly flow in the groove, such that ion substitution is not activated, and as a result, the tempered layer on the groove 20 portion is formed not to be deeper than that of the tempered layer on the other surface, as described above.

As described above, as the glass substrate is processed so that D is more than d (D>d) as shown in FIG. 4, since the chemical tempered layer 30 on the groove 20 portion is not thick, it may be easy to cut the glass substrate 10 at the groove 20 portion, and the strength of the substrate 10 may be maintained since the chemical tempered layer 30 partially remains at side end surfaces of the glass substrate 10 after cutting.

Productivity (cutting facility) and stability (a degree of maintaining strength) of the glass substrate manufactured by cutting the glass substrate 10 according to the exemplary embodiment of the present invention in the cell unit may be adjusted by an aspect ratio between a kerf to a depth of the groove 20 processed in advance in the glass substrate 10.

That is, when the aspect ratio is changed, an amount of ion substitution at the groove 20 portion is changed, such that a depth of the chemical tempered layer 30 in a width direction may be differently adjusted. The aspect ratio may be variously adjusted according to the cutting method of the glass substrate 10.

As described above, the glass substrate 10 according to the exemplary embodiment of the present invention may be cut by the method such as the laser cutting method, the water jet cutting method, the etching method, and the like. The aspect ratio of the groove 20 formed in the glass substrate 10 may be adjusted to 1.0 to 3.0 according to the change of the cutting method.

Meanwhile, before the sensor process is carried out after processing the groove 20 in the glass substrate 10, the groove 20 is filled with a resin, or the like, and then subsequent processes may be performed.

Therefore, the process may be performed equally to the case in which the groove is not processed so that a change in the shape of the glass substrate 10 by processing the groove 20 does not affect the subsequent processes. The resin filled in the groove may be removed after the process in the cell unit is completed.

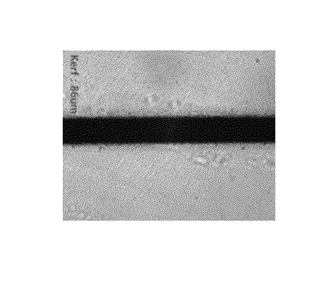

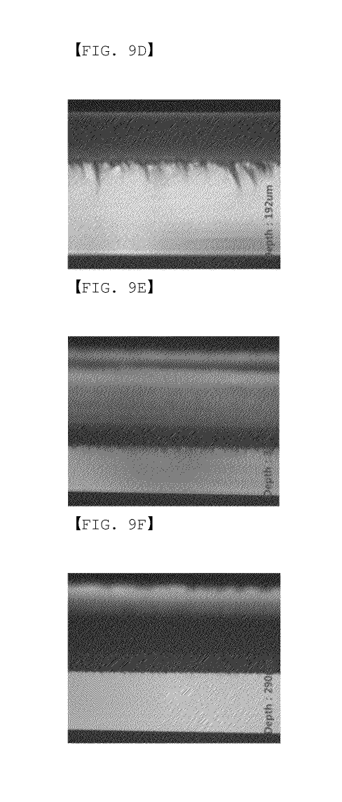

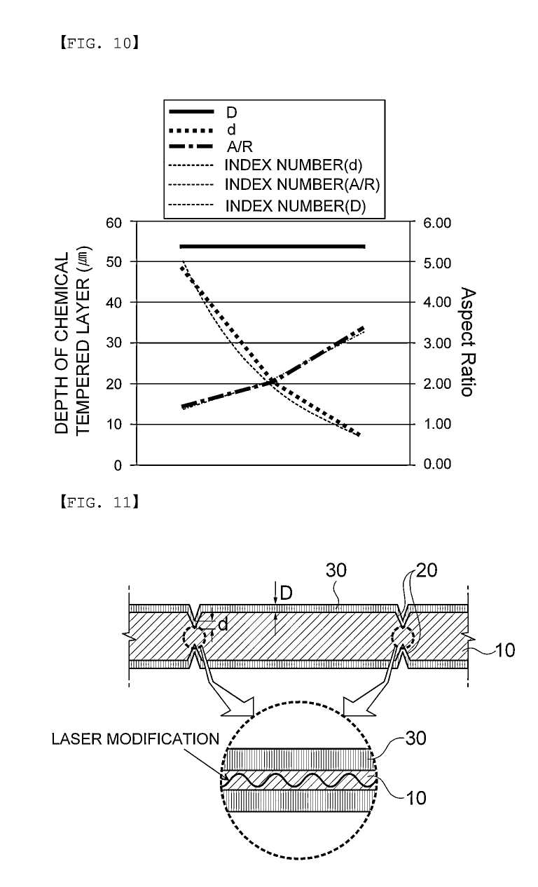

FIGS. 5A and 5B are cross-sectional views showing a cell shaped glass substrate according to the exemplary embodiment of the present invention; FIG. 6 is conceptual view showing a chemical tempering process according to the exemplary embodiment of the present invention; FIG. 7 is conceptual view showing a chemical tempered layer of a groove portion according to the exemplary embodiment of the present invention; FIGS. 8A and 8C are cross-sectional views showing grooves according to the exemplary embodiment of the present invention; FIGS. 9A to 9F are photographs of the grooves of FIGS. 8A to 8C; FIG. 10 is a graph showing relationship of a thickness of the chemical tempered layer to an aspect ratio of each of the grooves of FIGS. 8A to 9F; and FIG. 11 is conceptual view showing a laser cutting process according to the exemplary embodiment of the present invention. Referring to FIGS. 5A to 11, a glass substrate 10, grooves 20, a processing part 22, a chemical tempered layer 30 is shown.

As described above, the manufacturing method of a touch panel integrated with a cover glass may be divided into a cell type manufacturing method and a sheet type manufacturing method. Among them, the sheet type method, which is a method of cutting glass after chemical tempering the sheet shaped glass and manufacturing a touch sensor, may be preferable due to low cost and high productivity.

However, the sheet type method has a problem in that the strength of the glass may be decreased after cutting. The touch panel integrated with a cover glass according to the exemplary embodiment of the present invention may be manufactured by processing a region of the glass in the shape of the groove 20 in advance in to be finally cut, chemical tempering the glass, vertically adjusting a laser focus with respect to a non-tempered part of the groove 20 portion to modify non-tempered glass (See FIG. 11), and then apply relatively weak external force to cut the glass.

The chemical tempering process may be performed as shown in FIG. 6. In this case, since ion substitution at the portion at which the groove 20 is processed is not smoothly performed as shown in FIG. 5, this portion is tempered to have a DoL (See ‘d’ of FIG. 5) shallower than a DoL (See ‘D’ of FIG. 5) of the other portion.

Therefore, even though a glass substrate may not be cut at the existing DoL (for example, 50 μm), since the portion at which the groove 20 is processed has shallower DoL, the cutting may be performed.

In addition, since the side of the glass may be tempered in the cell unit along the shape of the process groove 20, an area of the side that is not tempered may be significantly decreased, thereby making it possible to prevent the strength of the glass substrate from be decreased and increase the strength of the glass substrate.

Therefore, the touch panel integrated with a cover glass according to the present invention has a structure in which the chemical tempered layer 30 is stacked on the glass substrate 10 in the cell unit, but an edge of the glass substrate 10 is formed with a processed part 20.

The chemical tempered layer 30 may be classified into a first chemical tempered layer 30 stacked on the surface of the glass substrate 10 and a second chemical tempered layer 30b stacked on the processed part 20. In the present embodiment, the touch panel is manufactured by processing and treating the glass substrate so that a thickness D of the first chemical tempered layer 30 is thicker than a thickness d of the second chemical tempered layer 30 as shown in FIG. 5A.

The glass substrate 10 according to the exemplary embodiment of the present invention may be formed in a square shape having a predetermined thickness as shown in FIG. 5B. Here, the processed parts 20 may be formed at the edge of the glass substrate 10, that is, four sides of the square (3 to 6 surfaces in FIGS. 5 A and 5B).

The cell shaped glass substrate 12 according to the exemplary embodiment of the present invention may be formed by forming the groove 20 in advance in the sheet shaped glass substrate 10, performing the chemical tempering on the glass substrate 10, and then cutting the glass substrate 10 along the groove 20.

Therefore, as shown in FIG. 5A, the second chemical tempered layer 30b stacked on the portion (the processed part 22) in which the groove 20 is processed may have a thickness decreased toward the end portion of the glass substrate 12.

As described with reference to FIGS. 2A to 2O, the black decoration 40 may be printed in the cell unit on one surface of the sheet shaped glass substrate 10, the step coating layer 42 may be formed thereon so as to cover the black decoration 40, the X-axis transparent coating layer 45 including the X-axis stripe type electrodes 44 may be stacked on the step coating layer 42, and the Y-axis transparent coating layer 47 including the Y-axis stripe type electrodes 46 may be stacked on the X-axis transparent coating layer 45.

Further, as described above, the aspect ratio of the groove 20 formed in the glass substrate 10 may be 1.0 to 3.0, and the glass is modified by bringing the laser focus on the groove 20 portion and moving the laser focus along the groove 20, such that the glass substrate 10 is cut, thereby forming the process part 22 according to the present embodiment as shown in FIG. 11.

FIGS. 8A to 8C show examples of the case in which the groove is formed in the glass substrate so as to have various aspect ratios. The chemical tempering (KNO3) was performed at 450° C. for 8 hours after heating the glass in advance to 400° C.

Depths of the grooves shown in FIGS. 8A to 8C were compared with each other, and the results were shown in the following Table 1.

TABLE 1

| | A | B | C |
|---|---|---|---|
| Kerf | 135 μm | 167 μm | 86 μm |
| Depth | 192 μm | 337 μm | 290 μm |
| Aspect ratio | 1.42 | 2.02 | 3.37 |
| Depth of first | average 54 μm | average 54 μm | average 54 μm |
| chemical tempered | | | |
| layer (D) | | | |
| Depth of second | average | average 20.5 μm | average 6.9 μm |
| chemical tempered | 49.1 μm | | |
| layer (d) | | | |
| Kerf | See FIG. 9A | See FIG. 9B | See FIG. 9C |
| Depth | See FIG. 9D | See FIG. 9E | See FIG. 9F |

In addition, the relationship of the thickness of the chemical tempered layer to the aspect ratio of each of the grooves in FIGS. 8A to 8C is shown in FIG. 10.

As shown in FIGS. 8A to 10, the glass substrate is processed in a groove shape in advance and cut, such that the glass substrate that may not be cut at the depth of the tempered layer according to the related art may be cut (at the groove portion). In addition, the chemical tempered layers are partially formed on the sides of the glass substrate in the cell unit processed in the groove shape, such that the area of the side that is not tempered may be significantly decreased, thereby making it possible to increase the strength of the glass substrate.

With the touch panel integrated with a cover glass and the manufacturing method thereof according to the present invention, the touch panel may be manufactured in the cell unit by forming grooves in both surfaces of the sheet shaped tempered glass substrate, performing chemical tempering on the surface, and cutting the regions in which the grooves are formed, such that the cutting of the glass substrate may be easily performed, thereby making it possible to prevent the strength of the side of the tempered glass substrate from being reduced while having advantages such as low cost and high productivity.

The present invention has been described in connection with what is presently considered to be practical exemplary embodiments. Although the exemplary embodiments of the present invention have been described, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A manufacturing method of a touch panel integrated with a cover glass, the manufacturing method comprising:
providing a sheet shaped glass substrate;
forming grooves in cut regions of the glass substrate;
forming a chemical tempered layer on a surface of the glass substrate and groove portions through chemical tempering; and
cutting the glass substrate along the groove,
wherein a thickness D of the chemical tempered layer of the surface of the glass substrate is thicker than a thickness d of the chemical tempered layer on the groove portion.

2. The manufacturing method according to claim 1, further comprising, between the forming of the chemical tempered layer and the cutting of the glass substrate,
printing black decoration on one surface of the glass substrate; and
forming a step coating layer on the glass substrate so as to cover the black decoration.

3. The manufacturing method according to claim 2, further comprising, between the forming of the step coating layer and the cutting of the glass substrate,
forming stripe type electrodes on the step coating layer in a first axis direction;
forming a first transparent coating layer so as to cover the stripe type electrodes in the first axis direction;
forming stripe type electrodes on the first transparent coating layer in a second axis direction intersecting with the first axis direction; and
forming a second transparent coating layer so as to cover the stripe type electrode in the second axis direction.

4. The manufacturing method according to claim 1, wherein an aspect ratio of a kerf to a depth of the groove is 1.0 to 3.0.

5. The manufacturing method according to claim 1, wherein the cutting of the glass substrate includes modifying the groove portion by bringing laser focus on the groove portion and moving the laser focus along the groove.

6. The manufacturing method according to claim 1, wherein the cutting is performed by at least one method selected from a group consisting of a laser cutting method, a water jet cutting method, and an etching method.

7. The manufacturing method according to claim 1, further comprising, between the forming of the groove and the forming of the chemical tempered layer, filling the groove with a filler.

8. The manufacturing method according to claim 7, further comprising, after the cutting of the glass substrate, removing the filler.

9. The manufacturing method according to claim 1, further comprising, after the cutting of the glass substrate, performing at least one healing treatment selected from a group consisting of etching treatment and brushing treatment.

10. A touch panel integrated with a cover glass comprising:
a cell shaped glass substrate;
a processed part formed at en edge of the glass substrate;
a first chemical tempered layer formed on a surface of the glass substrate; and
a second chemical tempered layer formed on the processed part,
wherein the first chemical tempered layer has a thickness thicker than that of the second chemical tempered layer.

11. The touch panel integrated with a cover glass according to claim 10, wherein the glass substrate is formed in a square shape having a predetermined thickness, and the process part corresponds to four sides of the square.

12. The touch panel integrated with a cover glass according to claim 11, wherein the second chemical tempered layer has a thickness decreased toward an end portion of the glass substrate.

13. The touch panel integrated with a cover glass according to claim 12, wherein the cell shaped glass substrate is formed by forming grooves along predetermined cutting lines of a sheet shaped glass substrate, performing chemical tempering on the glass substrate, and cutting the glass substrate along the grooves.

14. The touch panel integrated with a cover glass according to claim 13, wherein the groove is filled with a filler.

15. The touch panel integrated with a cover glass according to claim 13, wherein black decoration is printed on one surface of the sheet shaped glass substrate so as to correspond to a shape of the cell, and a step coating layer is formed on one surface of the sheet shaped glass substrate so as to cover the black decoration.

16. The touch panel integrated with a cover glass according to claim 15, wherein a first transparent coating layer including stripe type electrodes in a first axis direction is stacked on the step coating layer, and a second transparent coating layer including stripe type electrodes in a second axis direction intersecting with the first axis direction is stacked on the first transparent coating layer.

17. The touch panel integrated with a cover glass according to claim 13, wherein an aspect ratio of a kerf to a depth of the groove is 1.0 to 3.0.

18. The touch panel integrated with a cover glass according to claim 10, wherein the processed part is modified by laser processing.
